(19) United States
(12) Patent Application Publication
(10) Pub. No.: US 2016/0203824 A1
(43) Pub. Date: Jul. 14, 2016

(54) AUDIO SIGNAL COMMUNICATION METHOD AND SYSTEM THEREOF

(71) Applicant: Electronics And Telecommunications Research Institute, Daejeon (KR)

(72) Inventors: Tae Jin PARK, Daejeon (KR); Seung Kwon BEACK, Seoul (KR); Jong Mo SUNG, Daejeon (KR); Yong Ju LEE, Daejeon (KR); Kyeong Ok KANG, Daejeon (KR); Jin Woong KIM, Daejeon (KR); Tae Jin LEE, Daejeon (KR)

(21) Appl. No.: 14/841,244

(22) Filed: Aug. 31, 2015

(30) Foreign Application Priority Data
Jan. 12, 2015 (KR) 10-2015-0004369

(51) Int. Cl. G10L 19/018

(52) U.S. Cl. CPC G10L 19/018

(57) ABSTRACT

Example embodiments of the present invention relate to an audio signal communication method at a transmitter and a receiver, and a system thereof. There may be provided an audio signal communication method which includes hiding data in an audio signal via audio watermarking and extracting a fingerprint of the audio signal, generating a transmit audio signal by audio-watermarking the audio signal from which the fingerprint is extracted with the data, extracting the fingerprint of the audio signal using the audio signal and the transmit audio signal, and transmitting the transmit audio signal to a receiver.

### CROSS-REFERENCE TO RELATED APPLICATION

This application claims the priority benefit of Korean Patent Application No. 10-2015-0004369, filed on Jan. 12, 2015, in the Korean Intellectual Property Office, the disclosure of which is incorporated herein by reference.

### BACKGROUND

1. Field of the Invention

Example embodiments of the present invention relate to an audio signal communication method at a transmitter and a receiver, and a system thereof.

2. Description of the Related Art

Audio watermarking is a technique of hiding, in an audio signal, a signal not readily detected by auditory organs of humans in order to embed data. Various audio watermarking methods are used for diverse applications. To date, audio watermarking has been used for digital rights management (DRM). Hidden data may be embedded through audio watermarking, thereby identifying and tracking a distribution route of audio content illegally copied and distributed without permission of a copyright holder.

Recently, audio watermarking has also been employed for acoustic data transfer (ADT) of transmitting data via an acoustic channel, in addition to DRM. ADT allows data exchanges via air vibrations, unlike conventional electromagnetic (EM) communications.

Unlike audio watermarking, audio fingerprinting quantizes a unique signal feature of an audio signal into data without modifying or editing the original audio signal. A feature extracted from each audio signal is uniqueness, similarity to a fingerprint of a human, which allows identification of the audio signal.

Audio fingerprinting involves a smaller amount of data to be processed than video fingerprinting employing a similar method, uses a sound as a transmission medium lacking directivity, unlike light used as a medium by a video camera and allows users to more conveniently receive data than video information, and thus this technique is widely used for music and content searches.

To apply audio fingerprinting in practice, all fingerprint data may need to be secured and stored in a server in a form of a database pool for retrieval. When the database is completely established, a user including a mobile terminal or the like may retrieve information on an audio signal from the database by matching using audio fingerprinting information from audio information collected for retrieval.

Audio watermarking and audio fingerprinting have advantages and disadvantages. Although audio watermarking may deform an audio signal inadvertently resulting in auditory damage to the audio signal, a database need not be established to transmit information through an audio signal, unlike audio fingerprinting.

Audio fingerprinting entails establishing a database, making it difficult to use audio fingerprinting for live broadcasts and the like. Audio fingerprinting does not embed information into an audio signal and thus, allows for an analysis of even previously generated audio signals. This advantage of audio fingerprinting is not provided by audio watermarking.

Existing audio watermarking techniques are limited mostly to DRM applications and are not generally used for data transmission from a speaker to a microphone through an acoustic channel. Similarly, use of audio fingerprinting has been limited, such as for content retrieval through an audio signal.

### SUMMARY

According to an aspect of the present invention, a technique of employing audio watermarking and audio fingerprinting in a combined manner is applied to an audio signal transmitted via a broadcast, and accordingly a terminal, such as a smart phone, a smart tablet and other smart devices, may analyze an audio signal transmitted via a television (TV) broadcast or radio broadcast after receiving the audio signal through a microphone, or a TV or radio terminal may receive an audio signal through a broadcast channel and analyze the audio signal.

In addition, another aspect of the present invention provides a technique capable of providing a user with a terminal watching a broadcast with electronic commerce information or content information via the Internet through a signal route and of allowing a broadcasting company or business company to perform monitoring, such as surveying viewer ratings and analyzing viewer propensities, through audio signals received by a user terminal.

According to an aspect of the present invention, there is provided an audio signal communication method including watermarking an audio signal to be transmitted with data to hide the data, extracting a fingerprint of the audio signal by comparing the audio signal to a data-hidden audio signal, storing the fingerprint in an audio feature database, and transmitting the data-hidden audio signal.

The data may include at least one of a content identifier (ID) and additional data.

The extracting of the fingerprint of the audio signal by comparing the audio signal to the data-hidden audio signal may include extracting identical fingerprints from the audio signal and the data-hidden audio signal by comparing the audio signal to the data-hidden audio signal.

The audio signal communication method may further include receiving, by a receiver, the transmitted audio signal through a broadcast channel.

The audio signal communication method may further include converting, by the receiver, the transmitted audio signal into an acoustic signal, extracting the data audio-watermarked and the fingerprint from the acoustic signal, and acquiring a content ID and additional data from the fingerprint.

The acquiring of the content ID and the additional data from the fingerprint may include acquiring the content ID and the additional data by referring to the audio feature database.

According to another aspect of the present invention, there is provided an audio signal communication method including receiving, by a receiver, a signal from a transmitter through a broadcast channel, converting the signal into an audio signal, extracting audio-watermarked data and a fingerprint from the audio signal, and acquiring a content ID and additional data from the data and the fingerprint.

The converting of the signal into the audio signal may include outputting the audio signal to an audio output device connected to the receiver.

The acquiring of the content ID and the additional data from the data and the fingerprint may include acquiring the content ID and the additional data by referring to an audio feature database of the transmitter storing the audio signal from which the fingerprint is extracted.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating an audio signal communication method performed at a transmitter according to an example embodiment of the present invention;

FIG. 2 is a flowchart illustrating an audio signal communication method performed at a receiver according to an example embodiment of the present invention;

FIG. 3 illustrates data flow when an acoustic channel is present at the receiver according to an example embodiment of the present invention; and

FIG. 4 illustrates data flow when an acoustic channel is absent at the receiver according to an example embodiment of the present invention.

### DETAILED DESCRIPTION

Hereinafter an audio signal communication method and an audio signal communication system will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The present invention employs two technologies together in order to transmit information through an audio watermark and to retrieve content using an audio fingerprint.

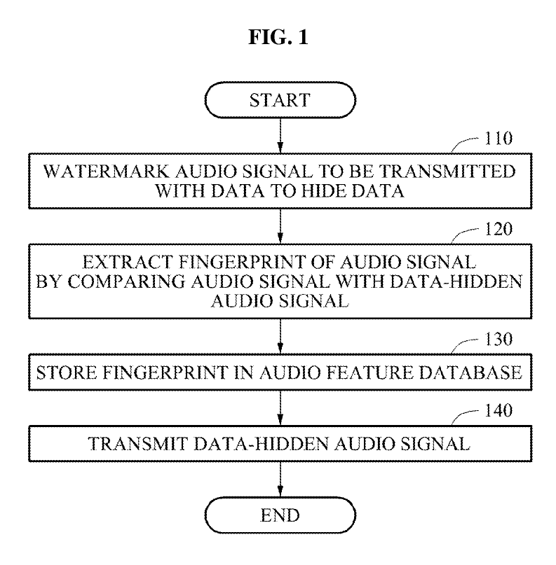

FIG. 1 is a flowchart illustrating an audio signal communication method performed at a transmitter according to an example embodiment of the present invention.

In operation 110, the transmitter may watermark an audio signal to be transmitted with data to hide the data.

The audio signal may be included in a radio broadcast signal or television (TV) broadcast signal. The transmitter may perform audio watermarking on the data to be hidden in the audio signal to be transmitted to a receiver.

In operation 120, the transmitter may extract a fingerprint of the audio signal by comparing the audio signal with the data-hidden audio signal.

The transmitter may extract the fingerprint as a unique feature of the audio signal by comparing the audio signal to the data-hidden audio signal.

Identical fingerprints may be extracted from the audio signal and the watermarked audio signal by comparing the original audio signal to the signal modified via watermarking and hiding.

As described above, the method according to the present invention may allow the original audio signal to be transmitted to be subjected to both a data hiding process, that is, an audio watermarking process, and an audio feature extraction process, that is, an audio fingerprint extraction process.

In operation 130, the extracted fingerprint may be stored in an audio feature database with respect to the audio signal from which the fingerprint is extracted.

The extracted fingerprint may be stored in the audio feature database and used as a reference by the receiver.

In operation 140, the transmitter may transmit the data-hidden audio signal to the receiver. The transmitted audio signal may be transmitted to the receiver, including information, such as additional data and a content identifier (ID), through the audio watermarking process and the audio feature extraction process.

In the embodiment, the additional data may be clothing or food advertising information in television dramas, or a winning rate, player information and match schedules in sports. The additional data may be artist information, performance schedules of related artist or the like in performances.

The content ID may refer to an identification number or unique serial number representing what type of content a drama or a movie is. For example, content ID KR20130411004321 may refer an identification number for a particular television drama or movie aired on Apr. 11, 2013.

When the data-hidden audio signal is transmitted, radio or TV broadcast channels, such as radio frequency resources, connected to the receiver may be used.

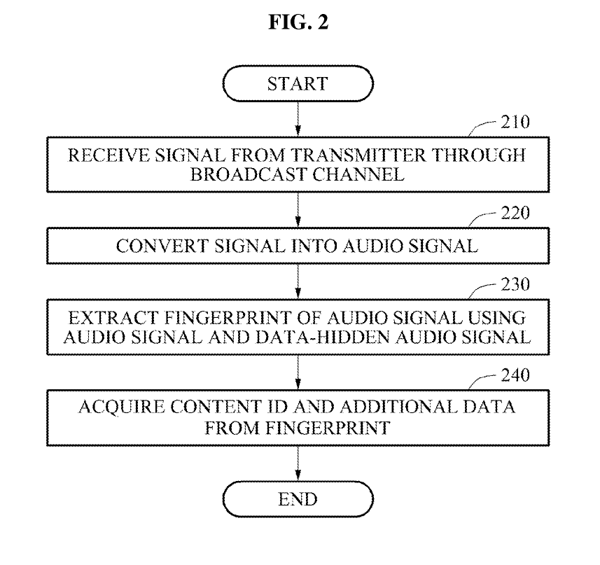

FIG. 2 is a flowchart illustrating an audio signal communication method performed at the receiver according to an example embodiment of the present invention.

An audio signal according to the embodiment may be an audio signal which is audio-watermarked with data and from which a fingerprint is extracted through the processes of FIG. 1.

In operation 210, the receiver may receive a signal from the transmitter through a broadcast channel.

The receiver may receive analog and digital data from a cable broadcast channel or wireless broadcast channel through the broadcast channel connected to a TV or radio.

In operation 220, the receiver may convert the received signal into an audio signal.

The receiver may include an audio output unit capable of outputting an audio signal, such as a speaker. The receiver may convert the received signal into the audio signal to be output and output the audio signal through the audio output unit.

The receiver may include a TV, a radio or the like, and the audio output unit may output an acoustic signal through a speaker or the like included in the TV, radio or the like.

In operation 230, the receiver may extract audio-watermarked data and a fingerprint from the audio signal. The receiver may extract the audio-watermarked data and fingerprint using the signal output through the audio output unit. Two extraction processes may be performed simultaneously.

In operation 240, the receiver may acquire a content ID and additional data from the data and fingerprint. In the embodiment, information to be transmitted by the transmitter, such as the additional data and content ID, may be identified through the processes of extracting the audio-watermarked data and fingerprint.

The information, such as the additional data and content ID, may be acquired by referring to an audio feature database which stores information on the audio signal from which the fingerprint is extracted.

The receiver may output an acoustic signal to extract the audio-watermarked data and fingerprint depending on the presence or absence of an acoustic channel.

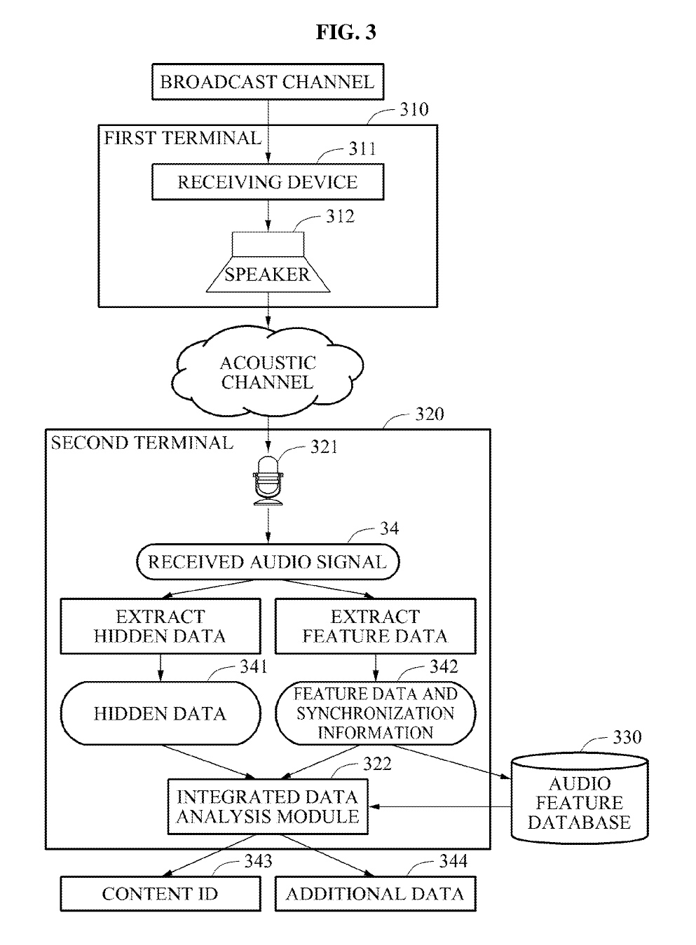

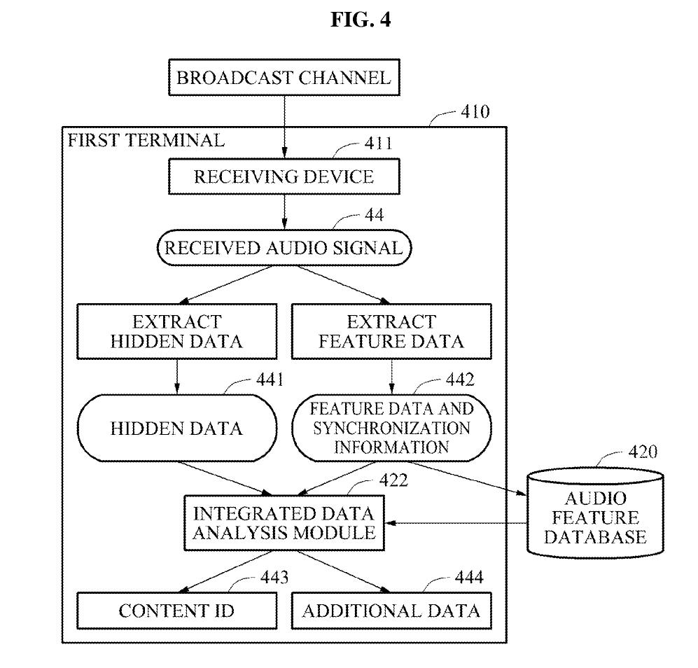

Hereinafter, FIGS. 3 and 4 illustrate data flows in the presence and absence of an acoustic channel at the receiver.

FIG. 3 illustrates data flow when an acoustic channel is present at the receiver according to an example embodiment of the present invention.

In the example embodiment, an audio signal which is audio-watermarked with data and from which a fingerprint is extracted through the processes of FIG. 1 may be received through a broadcast channel.

The receiver according to the example embodiment illustrated in FIG. 3 may include two terminals, hereinafter referred to as a first terminal 310 and a second terminal 320.

The first terminal 310 may be connected to cable and wireless broadcast channels and receive the audio signal through a receiving device 311. The received signal may be converted into an audio signal by an audio output unit, such as a speaker 312, of the first terminal 310 and be output. Accordingly, the audio signal included in the received signal may be output.

The output audio signal may be collected by the second terminal 320 through the acoustic channel. The acoustic channel may be the air to which the audio signal is output, and the audio signal may be input through an audio input unit, such as a microphone 321 of the second terminal 320.

Audio-watermarked hidden data 341 and a fingerprint, that is, feature data 342, may be extracted from the received audio signal 34 in the second terminal 320.

An integrated data analysis module 322 may identify additional data 343 and a content ID 344 included in the audio signal transmitted from the transmitter using the hidden data 341 and the feature data 342. In one embodiment, when the additional data and content ID are identified, the additional data and content ID may be acquired by referring to an audio feature database 330 obtained by the transmitter extracting and storing a fingerprint.

FIG. 4 illustrates data flow when an acoustic channel is absent at the receiver according to an example embodiment of the present invention.

The audio signal communication method according to the example embodiment of the present invention may include a system which extracts data through a single terminal and exchanges information without entailing processes of converting a received signal into an audio signal through the speaker of the first terminal at the receiver and collecting the audio signal through the second terminal including the microphone as illustrated in FIG. 3. The system illustrated in FIG. 4 may not convert a received signal into an audio signal in a first terminal 410 but only analyze a signal transmitted via a broadcast channel within the terminal.

In the example embodiment, the first terminal 410 may receive analog and digital data through a receiving device 421 from a cable broadcast channel or wireless broadcast channel via a broadcast channel connected to a TV or radio.

Audio-watermarked hidden data 441 and feature data 442, that is, a fingerprint, may be extracted from a received audio signal 44 in the first terminal 410.

Subsequently, an integrated data analysis module 422 receives and analyzes the hidden data 441 and the feature data 442 to identify additional data 443 and a content ID 444 included in the audio signal transmitted by the transmitter. In one embodiment, when the additional data and content ID are identified, the additional data and content ID may be acquired by referring to an audio feature database 420 obtained by the transmitter extracting and storing a fingerprint.

To apply audio watermarking and audio fingerprinting together to the embodiment, a unique audio fingerprint feature may need to remain unchanged even though the audio fingerprint feature is extracted from an audio file subjected to an audio watermarking process which modifies an audio signal. To this end, the system according to the present invention may satisfy the following technical conditions.

There is needed a technique for not allowing an audio signal modifying process to affect an audio feature or audio fingerprint and a technique for extracting the same audio feature or audio fingerprint as that of the original audio signal despite a small modification to the audio signal. Theoretically, one of these two technical solutions may not need to be considered when the other is perfect, but these two techniques may be complementary.

Technology according to the example embodiment of the present invention may fully achieve individual purposes of audio watermarking and fingerprint extraction.

In detail, audio fingerprint data may need updating to a server in real time in a live broadcast, making it difficult to identify a content ID using the audio fingerprint data. However, the present invention allows a content ID to be identified in a live broadcast using hidden data and a real-time hidden data encoder.

In typical filmed broadcasts other than live broadcasts, time positions of audio signals are identified using a previously established audio feature database to be utilized as synchronization information, thus allowing high-capacity and high-speed data transmission when compared to a conventional audio data hiding method which needs to perform separate time synchronization.

In addition, unlike music signals, audio signals of broadcast data include many silent intervals having no data, in which audio watermarking data hidden in audio data may be used in lieu of audio fingerprint data.

According to an aspect of the present invention, a technique employing audio watermarking and audio fingerprinting in a combined manner is applied to an audio signal transmitted via a broadcast, and accordingly a terminal, such as a smart phone, a smart tablet and other smart devices, may analyze an audio signal transmitted via a TV broadcast or radio broadcast after receiving the audio signal through a microphone, or a TV or radio terminal may receive an audio signal through a broadcast channel and analyze the audio signal.

In addition, another aspect of the present invention may provide a technique capable of providing a user with a terminal watching a broadcast with electronic commerce information or content information via the Internet through a signal route and of allowing a broadcasting company or business company to perform monitoring, such as surveying viewer ratings and analyzing viewer propensities, through audio signals received by a user terminal.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits are combined or coupled in different forms and modes than as described above or be substituted or switched with other components or equivalents.

Thus, other implementations, alternative embodiments and equivalents to the claimed subject matter are construed as being within the appended claims.

What is claimed is:

1. An audio signal communication method comprising:
watermarking an audio signal to be transmitted with data to hide the data;
extracting a fingerprint of the audio signal by comparing the audio signal to a data-hidden audio signal;
storing the fingerprint in an audio feature database; and
transmitting the data-hidden audio signal.

2. The audio signal communication method of claim 1, wherein the data comprises at least one of a content identifier (ID) and additional data.

3. The audio signal communication method of claim 1, wherein the extracting of the fingerprint of the audio signal by comparing the audio signal to the data-hidden audio signal comprises extracting identical fingerprints from the audio signal and the data-hidden audio signal by comparing the audio signal to the data-hidden audio signal.

4. The audio signal communication method of claim 1, further comprising receiving, by a receiver, the transmitted audio signal through a broadcast channel.

5. The audio signal communication method of claim 4, further comprising converting, by the receiver, the transmitted audio signal into an acoustic signal, extracting the data audio-watermarked and the fingerprint from the acoustic signal, and acquiring a content ID and additional data from the fingerprint.

6. The audio signal communication method of claim 5, wherein the acquiring of the content ID and the additional data from the fingerprint comprises acquiring the content ID and the additional data by referring to the audio feature database.

7. An audio signal communication method comprising:
receiving, by a receiver, a signal from a transmitter through a broadcast channel;
converting the signal into an audio signal;
extracting audio-watermarked data and a fingerprint from the audio signal; and
acquiring a content identifier (ID) and additional data from the data and the fingerprint.

8. The audio signal communication method of claim 7, wherein the converting of the signal into the audio signal comprises outputting the audio signal to an audio output device connected to the receiver.

9. The audio signal communication method of claim 7, wherein the acquiring of the content ID and the additional data from the data and the fingerprint comprises acquiring the content ID and the additional data by referring to an audio feature database of the transmitter storing the audio signal from which the fingerprint is extracted.
